(19) United States
(12) Patent Application Publication
(10) Pub. No.: US 2024/0120677 A1
(43) Pub. Date: Apr. 11, 2024

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Pipatthana PHATIWUTTIPAT, Mie (JP); Kenji MAKINO, Mie (JP)

(21) Appl. No.: 17/768,449

(22) PCT Filed: Aug. 21, 2020
(86) PCT No.: PCT/JP2020/031612

§ 371 Date: Apr. 12, 2022

(30) Foreign Application Priority Data
Oct. 29, 2019 (JP) 2019-195760

(51) Int. Cl. H01R 13/41

(52) U.S. Cl. CPC H01R 13/41

(57) ABSTRACT

The purpose of the present invention is to secure a long creepage distance between adjoining male terminal fittings. The connector (A) is provided with a housing (10) having a wall-like terminal holding section (11), multiple press-fit holes (13) formed in the terminal holding section (11), and multiple male terminal fittings (20) individually press-fitted in the multiple press-fit holes (13) and protruding from a rear surface (11R) of the terminal holding section (11) to the outside. Protrusions (16) are formed on the terminal holding section (11) so as to protrude from the rear surface (11R) of the terminal holding section (11) and arranged to separate adjoining press-fit holes (13) from each other.

### TECHNICAL FIELD

The present disclosure relates to a connector.

### BACKGROUND

Patent Document 1 discloses a connector in which a plurality of male terminal fittings are mounted through a wall portion of a housing. The plurality of male terminal fittings are arranged side by side at predetermined intervals in the wall portion.

### PRIOR ART DOCUMENT

### Patent Document

Patent Document 1: JP 2019-067685 A

### SUMMARY OF THE INVENTION

### Problems to be Solved

In the above connector, there is a concern that a current flows along a surface of the wall portion from the male terminal fitting on a high potential side to the male terminal fitting on a low potential side if a potential difference is produced between adjacent ones of the male terminal fittings.

A connector of the present disclosure was completed on the basis of the above situation and aims to ensure a long creepage distance between adjacent male terminal fittings.

### Means to Solve the Problem

The present disclosure is directed to a connector with a housing including a wall-like terminal holding portion, a plurality of press-fit holes formed in the terminal holding portion, and a plurality of male terminal fittings to be individually press-fit into the plurality of press-fit holes, the male terminal fittings projecting outward from a rear surface of the terminal holding portion, wherein the terminal holding portion is formed with a protrusion projecting from the rear surface of the terminal holding portion and disposed to partition between adjacent ones of the press-fit holes.

### Effect of the Invention

According to the present disclosure, it is possible to ensure a long creepage distance between adjacent male terminal fittings.

### BRIEF DESCRIPTION OF THE DRAWINGS

FIG. 1 is a perspective view of a connector of one embodiment.

FIG. 2 is a side view in section of the connector.

FIG. 3 is a front view of the connector.

FIG. 4 is an enlarged section along X-X of FIG. 3.

FIG. 5 is a partial enlarged section along Y-Y of FIG. 3.

### DETAILED DESCRIPTION TO EXECUTE THE INVENTION

### Description of Embodiments of Present Disclosure

First, embodiments of the present disclosure are listed and described.

(1) The connector of the present disclosure is provided with a housing including a wall-like terminal holding portion, a plurality of press-fit holes formed in the terminal holding portion, and a plurality of male terminal fittings to be individually press-fit into the plurality of press-fit holes, the male terminal fittings projecting outward from a rear surface of the terminal holding portion, wherein the terminal holding portion is formed with a protrusion projecting from the rear surface of the terminal holding portion and disposed to partition between adjacent ones of the press-fit holes. According to the configuration of the present disclosure, a creepage distance between adjacent ones of the male terminal fittings is a distance along a path detouring the protrusion. The connector of the present disclosure can ensure a long creepage distance between adjacent ones of the male terminal fittings as compared to the case where the protrusion does not project from the rear surface of the terminal holding portion.

(2) Preferably, an accommodating portion for surrounding the male terminal fitting with a clearance defined between the accommodating portion and the male terminal fitting is formed in a rear end part of the press-fit hole. According to this configuration, the creepage distance between the adjacent male terminal fittings is extended by a distance equivalent to an inner surface of the accommodating portion.

(3) Preferably, the male terminal fitting includes a protruding portion projecting in the same direction as an arrangement direction of the male terminal fittings, and a rear end of the protruding portion is located forward of a rear end of the protrusion. According to this configuration, even if a distance between the protruding portions of adjacent ones of the male terminal fittings is short, a long creepage distance between the male terminal fittings can be ensured.

(4) Preferably, the plurality of press-fit holes are disposed side by side in a row, and the terminal holding portion is formed with a rib projecting from the rear surface of the terminal holding portion and disposed to connect a plurality of the protrusions. According to this configuration, since the plurality of protrusions arranged at intervals in the arrangement direction of the press-fit holes are coupled by the rib, the deformation of the protrusions can be prevented.

### Details of Embodiment of Present Disclosure

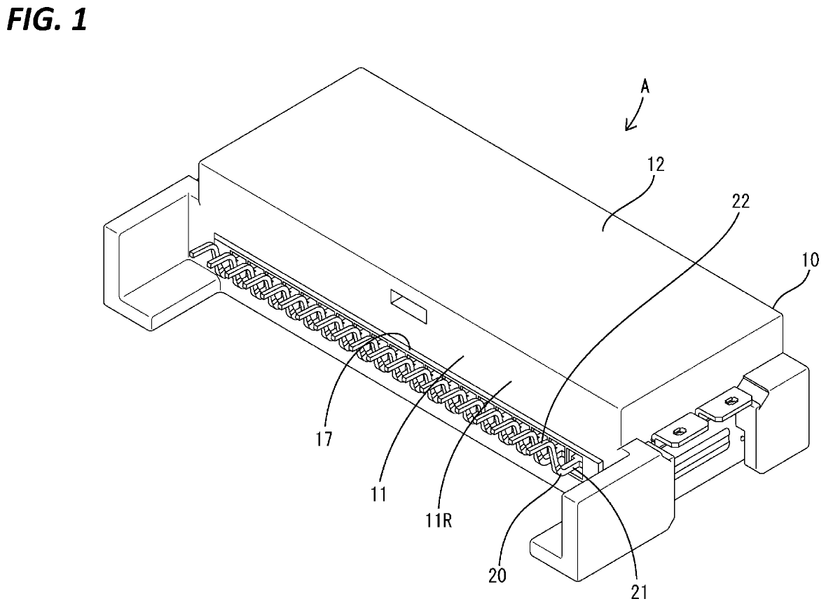

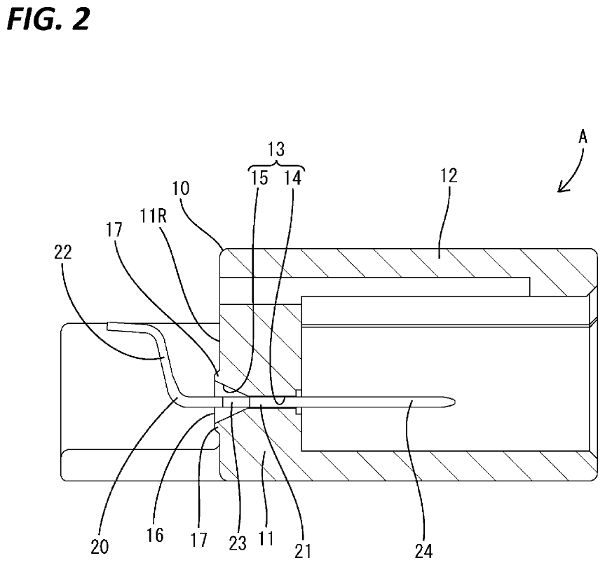

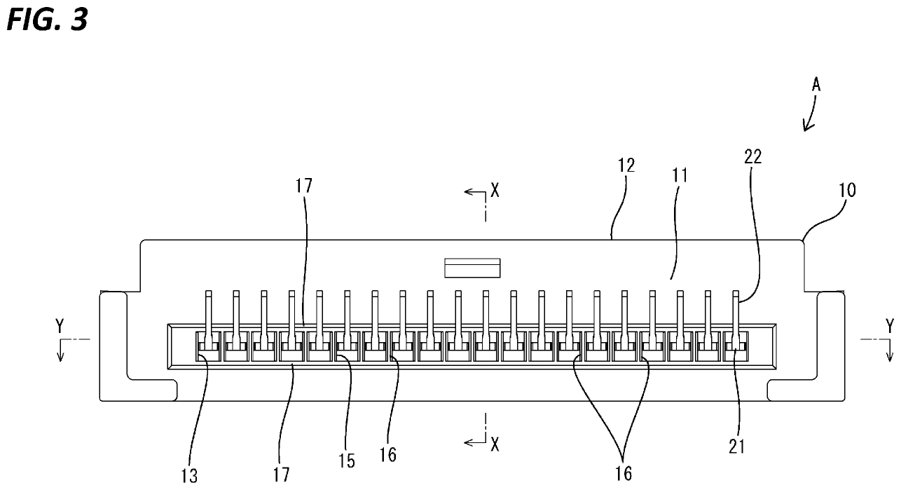

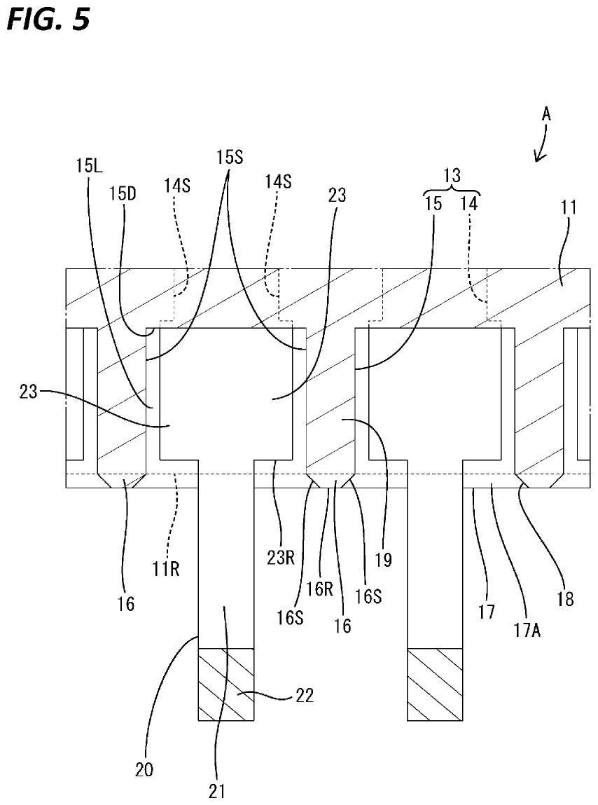

One specific embodiment of a connector A of the present disclosure is described with reference to FIGS. 1 to 5. Note that the present invention is not limited to these illustrations and is intended to be represented by claims and include all changes in the scope of claims and in the meaning and scope of equivalents. In this embodiment, an oblique right-upper side in FIG. 1 and a right side in FIGS. 2, 4 and 5 are defined as a front side concerning a front-rear direction. Upper and lower sides shown in FIGS. 1 to 4 are directly defined as upper and lower sides concerning a vertical direction. Left and right sides shown in FIGS. 3 and 5 are directly defined as left and right sides concerning a lateral direction.

The connector A of this embodiment is configured by assembling a housing 10 made of synthetic resin and a plurality of male terminal fittings 20 as shown in FIGS. 1 and 3. The housing 10 is a single component including a terminal holding portion 11 and a receptacle 12. The terminal holding portion 11 is a wall-like part rectangular in a front view of the housing 10 and having a thickness direction oriented in the front-rear direction. The receptacle 12 is in the form of a rectangular tube extending forward from the outer peripheral edge of the terminal holding portion 11.

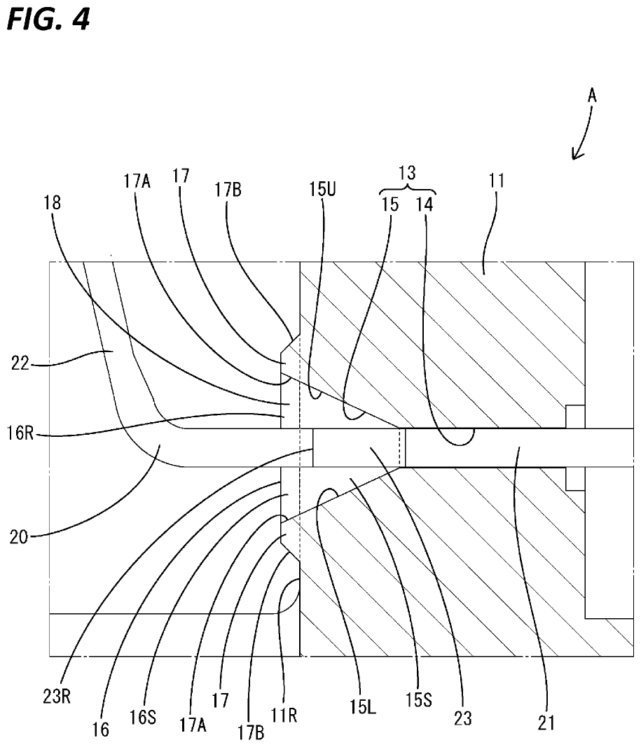

As shown in FIGS. 2 and 4, the terminal holding portion 11 is formed with a plurality of press-fit holes 13 penetrating through the terminal holding portion 11 in the front-rear direction. The plurality of press-fit holes 13 are arrayed at certain intervals in the lateral direction at the same height. The press-fit hole 13 includes a press-fitting portion 14 and an accommodating portion 15. The press-fitting portion 14 constitutes a front end side region of the press-fit hole 13. A cross-sectional shape of the press-fitting portion 14 perpendicular to the front-rear direction is a rectangular shape long in the lateral direction. As shown in FIG. 4, a vertical height of the press-fitting portion 14 is constant from the front end to the rear end of the press-fitting portion 14. A lateral width of the press-fitting portion 14 is constant from the front end to the rear end of the press-fitting portion 14.

The accommodating portion 15 constitutes a rear end side region of the press-fit hole 13, i.e. a region from the rear end of the press-fitting portion 14 to the rear end of the press-fit hole 13. The accommodating portion 15 is vertically symmetrically shaped and bilaterally symmetrically shaped. A lateral width of the accommodating portion 15 is larger than that of the press-fitting portion 14 and constant from the front end to the rear end of the accommodating portion 15. As shown in FIG. 5, front end parts of both left and right inner side surfaces 15S of the accommodating portion 15 are widened in a stepped manner with respect to both left and right inner side surfaces 14S of the press-fitting portion 14.

A height of the accommodating portion 15 gradually increases from the front end to the rear end of the accommodating portion 15. The height of the accommodating portion 15 at a front end is equal to that of the press-fitting portion 14. A cross-sectional shape of the front end of the accommodating portion 15 is a rectangular shape elongated in the lateral direction. The height of the accommodating portion 15 is largest at a rear surface 11R of the terminal holding portion 11. An opening shape of the accommodating portion 15 in the rear surface 11R of the terminal holding portion 11 is a square shape or nearly square rectangular shape. As shown in FIG. 4, the both left and right inner side surfaces 15S of the accommodating portion 15 have a trapezoidal shape with two parallel sides facing in the front-rear direction in a side cross-section of the housing 10. An upper inner surface 15U of the accommodating portion 15 is inclined to be gradually lower toward the front, and a lower inner surface 15L of the accommodating portion 15 is inclined to be gradually higher toward the front.

The terminal holding portion 11 is integrally formed with a plurality of protrusions 16 projecting from the rear surface 11R of the terminal holding portion 11 and a pair of upper and lower ribs 17 projecting from the rear surface 11R of the terminal holding portion 11. The plurality of protrusions 16 are arranged to partition between the press-fit holes 13 adjacent to each other in the lateral direction. The protrusion 16 is elongated in the vertical direction perpendicular to an arrangement direction of the press-fit holes 13. A vertical formation range of the protrusions 16 is the same region as an opening range of the press-fit holes 13 in the rear surface 11R of the terminal holding portion 11.

Both left and right outer side surfaces 16S of the protrusion 16 are obliquely connected to the rear end edges of the inner side surfaces 15S of the accommodating portion 15. Specifically, the both outer side surfaces 16S of the protrusion 16 are inclined in a tapered manner to gradually reduce a lateral width of the protrusion 16 toward the projecting end of the protrusion 16, i.e. a rear end 16R. The outer side surfaces 16S of two protrusions 16 located on both left and right sides of one press-fit hole 13 are positioned to face each other in the lateral direction. A facing distance between the two outer side surfaces 16S in one press-fit hole 13 is gradually widened toward the projecting ends of the protrusions 16. The projecting end surface of the protrusion 16 is a flat surface parallel to the rear surface 11R of the terminal holding portion 11.

The pair of upper and lower ribs 17 are elongated straight in parallel to the arrangement direction of the press-fit holes 13. The ribs 17 are arranged along the upper and lower edges, out of an opening edge of the press-fit hole 13 in the rear surface 11R of the terminal holding portion 11. The upper rib 17 is formed to couple the upper ends of the plurality of laterally arranged protrusions 16. The lower rib 17 is formed to couple the lower ends of the plurality of laterally arranged protrusions 16. Therefore, the plurality of protrusions 16 and the pair of upper and lower ribs 17 form a laid ladder shape in a back view of the housing 10.

An inner surface 17A of the rib 17 facing the press-fit holes 13 is flush and continuous with the inner side surfaces 15S of the accommodating portions 15. Specifically, the inner surface 17A of the upper rib 17 is at the same angle of inclination as the upper inner surfaces 15U of the accommodating portions 15 and extends obliquely to an upper-rear side from the rear ends of these upper inner surfaces 15U. An inner surface 17A of the upper rib 17 is at the same angle of inclination as the lower inner surfaces 15L of the accommodating portions 15 and extends obliquely to a lower-rear side from the rear ends of these lower inner surfaces 15L. An outer surface 17B of the upper rib 17 is connected at an obtuse angle to the upper end edge of the projecting end surface of the rib 17. An outer surface 17B of the lower rib 17 is connected at an obtuse angle to the lower end edge of the projecting end surface of the rib 17. A vertical dimension of the rib 17 is gradually reduced from the rear surface 11R of the terminal holding portion 11 toward the projecting end of the rib 17.

The projecting end surfaces of the ribs 17 are flat surfaces parallel to the rear surface 11R of the terminal holding portion 11. A projecting dimension of the ribs 17 from the rear surface 11R of the terminal holding portion 11 is equal to that of the protrusions 16 from the rear surface 11R of the terminal holding portion 11. Accordingly, the projecting end surfaces of the protrusions 16 and those of the ribs 17 are flush and continuous with each other. Two laterally adjacent protrusions 16 and parts of the ribs 17 connecting the laterally adjacent two protrusions 16 form a rectangular shape extending along a hole edge part of the press-fit hole 13. An opening space 18 defined as a space different from the press-fit hole 13 is configured by two protrusions 16 and the upper and lower ribs 17. The opening space 18 is continuous with the rear end of the press-fit hole 13 and is open rearward to the outside of the terminal holding portion 11.

The male terminal fitting 20 is formed by bending one elongated wire material. As shown in FIG. 2, the male terminal fitting 20 is a single component including a straight portion 21 extending straight in the front-rear direction, a board connecting portion 22 extending from the rear end of the straight portion 21 and a pair of left and right protruding portions 23. A front end side part of the straight portion 21 functions as a tab 24 to be connected to an unillustrated mating terminal. The board connecting portion 22 is bent into an L shape in a side view and extends upward from a rear end part of the straight portion 21.

The pair of protruding portions 23 protrude in the lateral direction from both left and right side edges of a region of the straight portion 21 near the rear end. The upper surface of the protruding portion 23 is flush and continuous with the upper surface of the straight portion 21, and the lower surface of the protruding portion 23 is flush and continuous with the lower surface of the straight portion 21. As shown in FIG. 5, a width of a part of the male terminal fitting 20 where the protruding portions 23 are formed is smaller than that of the accommodating portion 15. A front-rear dimension of the protruding portion 23 is equal to or slightly smaller than that of the accommodating portion 15.

The plurality of male terminal fittings 20 are press-fit into the press-fit holes 13 from behind the terminal holding portion 11. In press-fitting the male terminal fitting 20, rear ends 23R of the protruding portions 23 are pushed forward by an unillustrated jig with the tab 24 facing forward. By this pushing, the male terminal fitting 20 is mounted through the terminal holding portion 11. With the male terminal fitting 20 mounted through the terminal holding portion 11, the tab 24 projects forward of the terminal holding portion 11 and is surrounded by the receptacle 12. The board connecting portion 22 is exposed behind the terminal holding portion 11.

The protruding portions 23 are entirely accommodated in the press-fit hole 13. The rear ends 23R of the protruding portions 23 are located forward of the rear surface 11R of the terminal holding portion 11, i.e. the protrusions 16 and the ribs 17. Front end parts of the protruding portions 23 bite into a boundary part between the press-fitting portion 14 and the accommodating portion 15. The protruding portions 23 are positioned not to contact the both left and right inner side surfaces 15S of the accommodating portion 15 and the outer side surfaces 16S of the protrusions 16. In the accommodating portion 15, the protrusions 23 contact only the front end edge of the upper inner surface 15U, the front end edge of the lower inner surface 15L and a back end surface 15D of the accommodating portion 15.

If a potential difference is produced between two male terminal fittings 20 press-fit into the adjacent press-fit holes 13, a current attempts to flow between the both male terminal fittings 20. Since the accommodating portions 15 of the press-fit holes 13 are exposed on the outer surface of the housing 10, i.e. the rear surface 11R of the terminal holding portion 11, the surface of a partition wall portion 19 defining the laterally adjacent accommodating portions 15 serves as a path of a current flowing between the both male terminal fittings 20. Specifically, the path of the current is a path extending from the front end parts of the protruding portions 23 of one male terminal fitting 20, passing through the inner side surface 15S of one accommodating portion 15, out of the partition wall portion 19, turned at a projecting end part of the partition wall portion 19, passing through the inner side surface 15S of the other accommodating portion 15, out of the partition wall portion 19, and leading to the protruding portions 23 of the other male terminal fitting 20.

If a creepage distance along this path is long, the generation of a current between the adjacent male terminal fittings 20 can be avoided. Accordingly, the protrusion 16 is formed to project on the projecting end surface of the partition wall portion 19, i.e. between the opening edges of the adjacent accommodating portions 15. In this way, the creepage distance is ensured to be longer by a projecting dimension of the projecting portion. Therefore, the generation of a current between the adjacent male terminal fittings 20 can be avoided.

The connector A of this embodiment is provided with the housing 10 including the wall-like terminal holding portion 11 and the plurality of male terminal fittings 20. The housing 10 includes the wall-like terminal holding portion 11, and the terminal holding portion 11 is formed with the plurality of press-fit holes 13. The plurality of male terminal fittings 20 are individually press-fit into the plurality of press-fit holes 13. Parts of the male terminal fitting 20, i.e. the rear end part of the straight portion 21 and the board connecting portion 22, project to the outside of the housing 10 from the rear surface 11R of the terminal holding portion 11.

The terminal holding portion 11 is formed with the protrusions 16 projecting from the rear surface 11R of the terminal holding portion 11 and disposed to partition between adjacent ones of the press-fit holes 13. The creepage distance between adjacent ones of the male terminal fittings 20 is a distance along the path detouring the protrusion 16. Accordingly, the connector A of this embodiment can ensure a long creepage distance between adjacent ones of the male terminal fittings 20 as compared to the case where the protrusions 16 do not project from the rear surface 11R of the terminal holding portion 11.

The rear end part of the press-fit hole 13 is formed with the accommodating portion 15 surrounding the male terminal fitting 20 with a clearance defined between the accommodating portion 15 and the male terminal fitting 20. That is, the male terminal fitting 20 is not in contact with the inner side surfaces of the accommodating portion 15. According to this configuration, the creepage distance between adjacent ones of the male terminal fittings 20 is extended by a distance equivalent to a dimension in the front-rear direction of the inner side surfaces 15S of the accommodating portion 15 as compared to the case where the male terminal fitting 20 is in contact with the inner side surfaces 15S of the accommodating portion 15.

The male terminal fitting 20 includes the pair of protruding portions 23 projecting in the lateral direction, which is the same direction as the arrangement direction of the male terminal fittings 20. The rear ends 23R of the protruding portions 23 are located forward of the rear ends 16R of the protrusions 16, i.e. the projecting ends of the protrusions 16. According to this configuration, even if a distance between the protruding portions 23 of adjacent ones of the male terminal fittings 20 is short, the creepage distance between the male terminal fittings 20 can be ensured to be long.

The plurality of press-fit holes 13 are disposed side by side in a row in the lateral direction. The terminal holding portion 11 is formed with the ribs 17 projecting from the rear surface 11R of the terminal holding portion 11 and disposed to connect the plurality of protrusions 16 to each other. According to this configuration, since the plurality of protrusions 16 arranged at intervals in the arrangement direction of the press-fit holes 13 are coupled by the ribs 17, the deformation of the protrusions 16 can be prevented.

### Other Embodiments

The present invention is not limited to the above described and illustrated embodiment and is represented by claims. The present invention is intended to include all changes in the scope of claims and in the meaning and scope of equivalents and also include the following embodiments.

Although the accommodating portion formed in the rear end part of the press-fit hole surrounds the male terminal fitting with a clearance defined between the accommodating portion and the male terminal fitting in the above embodiment, the press-fit hole may not include such an accommodating portion.

Although the rear ends of the protruding portions are located forward of the rear ends of the protrusions in the above embodiment, the rear ends of the protruding portions may be at the same position as the rear ends of the protrusions or at a position rearward of the rear ends of the protrusions in the front-rear direction.

Although the ribs connecting the protrusions to each other are formed on the rear surface of the terminal holding portion in the above embodiment, the terminal holding portion may not be formed with such ribs.

List of Reference Numerals

| A | connector |
|---|---|
| 10 | housing |
| 11 | terminal holding portion |
| 11R | rear surface of terminal holding member |
| 12 | receptacle |
| 13 | press-fit hole |
| 14 | press-fitting portion |
| 14S | left/right inner side surface |
| 15 | accommodating portion |
| 15D | back end surface of accommodating portion |
| 15L | lower inner surface of accommodating portion |
| 15S | inner side surface of accommodating portion |
| 15U | upper inner surface of accommodating portion |
| 16 | protrusion |
| 16R | rear end of protrusion |
| 16S | outer side surface of protrusion |
| 17 | rib |
| 17A | inner surface of rib |
| 17B | outer surface of rib |
| 18 | opening space |
| 19 | partition wall portion |
| 20 | male terminal fitting |
| 21 | straight portion |
| 22 | board connecting portion |
| 23 | protruding portion |
| 23R | rear end of protruding portion |
| 24 | tab |

1. A connector, comprising:
a housing including a wall-like terminal holding portion;
a plurality of press-fit holes formed in the terminal holding portion, the press-fit holes being disposed side by side in a row; and
a plurality of male terminal fittings to be individually press-fit into the plurality of press-fit holes, the male terminal fittings projecting outward from a rear surface of the terminal holding portion,
wherein:
the terminal holding portion is formed with a protrusion projecting from the rear surface of the terminal holding portion and disposed to partition between adjacent ones of the press-fit holes,
the protrusion is formed along a hole edge part of the press-fit hole,
an outer side surface of the protrusion is continuous with an inner side surface of a rear end part of the press-fit portion,
the male terminal fitting includes a protruding portion projecting in the same direction as an arrangement direction of the male terminal fittings,
the protruding portion is entirely accommodated in the press-fit hole, and
a rear end of the protruding portion is located forward of a rear end of the protrusion.

2. The connector of claim 1, wherein an accommodating portion for surrounding the male terminal fitting with a clearance defined between the accommodating portion and the male terminal fitting is formed in the rear end part of the press-fit hole.

3. (canceled)

4. The connector of claim 1, wherein:
a plurality of the protrusions are elongated in a direction perpendicular to the arrangement direction of the plurality of press-fit holes,
the terminal holding portion is formed with a pair of ribs projecting from the rear surface of the terminal holding portion and disposed to connect end parts of the plurality of protrusions, and
the plurality of protrusions and the pair of ribs form a ladder shape.
